(19) United States
(12) Patent Application Publication
(10) Pub. No.: US 2026/0139142 A1
(43) Pub. Date: May 21, 2026

(54) EFFICIENT PROCESS OF ETCHING HIGHLY GRAPHITIC CARBONS

(71) Applicant: Cabot Corporation, Boston, MA (US)

(72) Inventors: Brian Mahoney, Somerville, MA (US); William C. Holler, Ayer, MA (US); Jeffrey S. Sawrey, Westford, MA (US); Qian Ni, Billerica, MA (US); Akshay Gopan, Somerville, MA (US); Andriy Korchev, Westford, MA (US)

(21) Appl. No.: 19/484,559

(22) PCT Filed: Jul. 17, 2025
(86) PCT No.: PCT/US2025/038059

§ 371 Date: Nov. 14, 2025

Related U.S. Application Data
(60) Provisional application No. 63/674,448, filed on Jul. 23, 2024.

(51) Int. Cl. C09C 1/56; C09C 1/54

(52) U.S. Cl. CPC C09C 1/56; C09C 1/54; C01P 2002/60; C01P 2004/64; C01P 2006/12; C01P 2006/14; C01P 2006/16; C01P 2006/80

(57) ABSTRACT

A method of increasing porosity of graphitic carbon black comprises combining graphitic carbon black having a Raman planar size (La) of at least 20 Angstroms with at least 100 ppm of an alkaline earth element selected from strontium, barium, and a mixture of both to form a mixture, and contacting the mixture with an etchant at a temperature of 900-1400° C. until 2%-85% of the mass of the carbon black is lost.

### BACKGROUND OF THE INVENTION

### 1. Field

Disclosed herein are methods of etching highly graphitic carbons and etched carbons produced thereby.

### 2. Description of the Related Art

Applications such as electric vehicles and storage for renewable energy sources are placing strong demands on lead acid batteries in terms of improved cyclability at high rate-partial state of charge (HRPSoC) conditions and high dynamic charge acceptance (DCA). Benefits of carbon additives in reducing negative plate sulfation and improving the cyclability and charge acceptance of valve regulated lead acid (VRLA) batteries have been demonstrated. Suitable carbon additives include carbon blacks. Carbon blacks are carbon materials with a unique hierarchical structure made from hydrocarbon feedstock in a high temperature, high throughput process. Characteristics of carbon blacks such as morphology, purity and surface properties have been studied in the context of lead acid battery applications.

Highly graphitic carbon black, such as those produced from acetylene as a starting material or via at least partial graphitization of furnace carbon blacks, have excellent thermal and electrical conductivity. In general, carbon blacks having larger specific surface areas exhibit higher conductivities. High surface area is traditionally correlated with small primary particle size. While steam can be used to etch carbon particles, amorphous carbons are more efficiently etched than the graphitic regions of carbon particles. Thus, it is desirable to have a more efficient method of etching carbon black, especially highly graphitic carbon blacks.

### SUMMARY

In one embodiment, a carbon black has the following characteristics: Raman planar size (La) of at least 21.5 Angstroms, a cumulative pore volume of pores having a diameter of 2 nm-6 nm of at least 0.1 cc/g, and at least 200 ppm strontium, barium, or both. The carbon black may have a BET surface area of 150 m²/g to 2000 m²/g. The carbon black may have a cumulative pore volume in cc/g of pores having a diameter of 2 nm-6 nm of at least 0.0004(BET)-0.048, wherein BET is the BET surface area according to ASTM 6556 with samples outgassed at 300° C. for one hour under nitrogen flow and measurements made over the nitrogen partial pressure range 0.05-0.1 P/Pₒ. The carbon black may have a crystallite size Lc of at least 10 Angstroms.

In another embodiment, a method of increasing porosity of graphitic carbon black comprises combining graphitic carbon black having a Raman planar size (La) of at least 20 Angstroms with at least 100 ppm of an alkaline earth element selected from strontium, barium, and a mixture of both to form a mixture, and contacting the mixture with an etchant at a temperature of 900-1400° C. until 2%-85% of the mass of the carbon black is lost. The graphitic carbon black, prior to contacting, may have a crystallite size Lc of at least 10 Angstroms.

Contacting may be performed until a BET surface area of the carbon black is at least doubled, for example, at least trebled. The rate of mass loss may be at least 10% greater than without the use of strontium or barium. The increase in pore volume of pores with 2-6 nm diameter may be at least 2.5% greater than without the use of strontium or barium. The etchant may be selected from the group consisting of O₂, O₃, an oxygen-containing acid, water (e.g., steam), CO₂, and combinations of two or more of these.

In another embodiment, a method of producing porous graphitic carbon black comprises thermally decomposing hydrocarbon feedstock to obtain graphitic carbon black and contacting the graphitic carbon black with an etchant and at least 100 ppm of an alkaline earth element selected from strontium, barium, and a mixture of both to form a mixture. Thermally decomposing and contacting may be performed in a single reactor. Contacting may be performed at a temperature from 1600° C. to 2700° C. The etchant may be selected from the group consisting of O₂, O₃, an oxygen-containing acid, water (e.g., steam), CO₂, and combinations of two or more of these.

In another embodiment, the porous graphitic carbon black is incorporated into a cathode, a conductive plastic, a catalyst, a fuel cell catalyst, or a supercapacitor

### DETAILED DESCRIPTION

In one embodiment, a method of increasing porosity of graphitic carbon black, comprises combining carbon black having a Raman planar size (La) of at least 20 Angstroms with at least 100 ppm strontium and/or barium to form a mixture; and contacting the mixture with an oxidant and/or etchant at a temperature of 900-1400° C. until 2%-85% of the mass of the carbon black is lost.

The graphitic carbon black may be any highly graphitic carbon black. For example, the carbon black may be an acetylene black. Exemplary acetylene blacks include DENKA BLACK materials from Denka Company Ltd., AB50P acetylene black available from IRPC Public Company Limited, and acetylene blacks available from Orion Engineered Carbons GmbH, Polimax, and Soltex, Inc. Acetylene blacks from other sources not listed herein are also known to those of skill in the art and are suitable for use with the methods provided herein.

Alternatively or in addition, the graphitic carbon black may be a partially or fully graphitized furnace black. Furnace carbon blacks are generally amorphous. However, their crystallinity may be increased by heating them in an inert atmosphere, for example, at a temperature from 1100° C. to 2000° C. Suitable partially or fully graphitized furnace blacks may be produced using any of the methods described in WO2005028569, U.S. Pat. No. 4,601,887, 4,351,815, EP1164651, U.S. Pat. Nos. 4,160,813, 11,352,536, 9,017,837, 9,287,565, 10,135,071, and 10,971,730, the entire contents of all of which are incorporated herein by reference.

Alternatively or in addition, commercially available graphitic carbon blacks include LITX® 50, LITX® 66, LiTX® 200, LiTX® 300, FCX® 80, and LITX@HP carbons from Cabot Corporation; C-NERGY™ C45, C-NERGY™ C65, Ensaco® 250G, Ensaco® 250P, and SUPER P® products from Imerys; Li-400, Li-250, Li-100 and Li-435 products from Denka; and the EC300 and EC600 products from Ketjen.

The graphitic carbon black, prior to etching, may have a Raman planar size (La) of at least 20 Angstroms, for example, from 20 to 80 Angstroms, for example, 25-70 Angstroms, 30 to 60 Angstroms, or 35 to 55 Angstroms.

Raman measurements of La (planar size) were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands at about 1340 cm-1 and 1580 cm-1, denoted as the “D” and “G” bands, respectively. It is generally considered that the D band is attributed to disordered sp2 carbon and the G band to graphitic or “ordered” sp2 carbon. Using an empirical approach, the ratio of the G/D bands and the La measured by X-ray diffraction (XRD) are highly correlated, and regression analysis gives the empirical relationship: La=43.5×(band area G/band area D) in which La is calculated in Angstroms. Thus, a higher La value corresponds to a more ordered crystalline structure.

The graphitic carbon black, prior to etching, may have any suitable BET surface area, as measured by ASTM 6556 with samples outgassed at 300° C. for one hour under nitrogen flow and measurements made over the nitrogen partial pressure range 0.05-0.1 P/Pₒ. For example, the graphitic carbon black, prior to etching, may have a BET surface area of 50 to 1300 m²/g, for example, from 50 to 400, from 400 to 800, from 800 to 1100, or from 1100 to 1300 m²/g.

Alternatively or in addition, the graphitic carbon black, prior to etching may have a crystallite Lc as measured by x-ray diffraction of at least 10 Angstroms, for example, at least 15 Angstroms, at least 17 Angstroms, from 20 to 80 Angstroms, from 25 to 70 Angstroms, or from 25 to 65 Angstroms. The Lc crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the Lc crystallite size was determined using the Scherrer equation: Lc (A)=K*λ/(β*cos θ), where K is the shape factor constant (0.9); λ is the wavelength of the characteristic X-ray line of Cu K_{α1} (1.54056 Å); β is the peak width at half maximum in radians; and θ is determined by taking half of the measuring angle peak position (2θ).

Alternatively or in addition, the graphitic carbon black, prior to etching, may have a surface energy (SE) of 10 mJ/m² or less, 9 mJ/m² or less, 8 mJ/m² or less, 7 mJ/m² or less, 6 mJ/m² or less, 5 mJ/m² or less, or 3 mJ/m² or less. In the same and other embodiments, the partially crystallized carbon black has a surface energy (SE) of greater than 0 mJ/m², greater than 1 mJ/m², greater than 2 mJ/m², greater than 3 mJ/m², greater than 4 mJ/m², greater than 5 mJ/m², greater than 6 mJ/m², greater than 7 mJ/m², greater than 8 mJ/m² or greater than 9 mJ/m². That is, the surface energy of the graphitic carbon black, prior to etching, may be in any range defined by any pair of upper and lower bounds provided above.

The surface energy (SE) of a carbon black particle can be determined by measuring the water vapor adsorption using a gravimetric instrument. The carbon black sample is loaded onto a microbalance in a humidity chamber and allowed to equilibrate at a series of step changes in relative humidity. The change in mass is recorded. The equilibrium mass increase as a function of relative humidity is used to generate the vapor adsorption isotherm. Spreading pressure (in mJ/m²) for a sample is calculated as π_{c}/BET, in which:

π_{c}=RT∫₀ p⁰ Γd ln p

and R is the ideal gas constant. T is temperature, Γ is moles of water adsorbed, p⁰ is the vapor pressure, and p is the partial pressure of the vapor at each incremental step. The spreading pressure is related to the surface energy of the solid and is indicative of the hydrophobic/hydrophilic properties of the solid, with a lower surface energy (SE) corresponding to a higher hydrophobicity.

The porosity and surface area of the graphitic carbon black may be increased by any oxidative etching method, for example, the methods described in U.S. Ser. No. 10/087,330 or U.S. Pat. No. 9,017,837, the entire contents of both of which are incorporated by reference. The etching preferably comprises contacting a portion of the graphitic carbon black with one or more etchants, e.g., O₂, O₃, an oxygen-containing acid, water (e.g., steam), or CO₂, in the presence of a strontium and/or barium catalyst as described below, under conditions effective to etch the graphitic carbon black, for example, by oxidative processes, and increase its porosity, especially the volume of pores having a diameter of 2-6 nm. In certain embodiments, the etching comprises a steam-etching process. As used herein, the term “steam etching” means etching the graphitic carbon black with an etching medium, wherein the etching medium comprises steam. For example, the etching agent may comprise at least 50 wt. % steam, at least 75 wt. % steam, at least 90 wt. % steam or 100% steam.

Etching is conducted in the presence of a strontium and/or barium catalyst. The strontium and/or barium may be introduced as a nitrate, hydroxide, acetate, chloride or other salt known to those of skill in the art. The catalyst may be introduced in an amount of 100 to 10,000 ppm with respect to the graphitic carbon black, for example, from 100 to 200 ppm, from 200 to 300 ppm, from 300 to 400 ppm, from 400 to 500 ppm, from 500 to 600 ppm, from 600 to 700 ppm, from 700 to 800 ppm, from 800 to 900 ppm, from 900 to 1000 ppm, from 1000 to 1200 ppm, from 1200 to 1400 ppm, from 1400 to 1600 ppm, from 1600 to 1800 ppm, from 1800 to 2000 ppm, from 2000 to 2200 ppm, from 2200 to 2400 ppm, from 2400 to 2600 ppm, from 2600 to 2800 ppm, from 2800 to 3000 ppm, from 3000 to 3500 ppm, from 3500 to 4000 ppm, from 4000 to 4500 ppm, from 4500 to 5000 ppm, from 5000 to 6000 ppm, from 6000 to 7000 ppm, from 7000 to 8000 ppm, from 8000-9000 ppm, or from 9000 to 10000 ppm.

The catalyst may be introduced to the graphitic carbon black using any method known to those of skill in the art. For example, an aqueous solution of the catalyst may be used in a wet pelletization process. Alternatively, an aqueous solution of the catalyst may be sprayed on the graphitic carbon black, either in densified or undensified form, and allowed to dry, leaving the catalyst on the surface of the carbon black.

The etching may be conducted in any suitable heater, for example a rotary kiln, a multiple hearth furnace, a fluidized bed reactor, or other heater known to those of skill in the art. During etching, the etchant is passed through the furnace containing the graphitic carbon black. The etchant is optionally combined with a diluent, a material that is passed through the heater primarily for a reason other than to etch or oxidize the graphitic carbon black starting material. For example, the diluent may comprise an inert gas, e.g., nitrogen or argon. Thus, a reaction gas that is passed through the heater may include only the etchant or a blend of the etchant and the diluent. The ratio of the etchant and diluent may be adjusted to control the etching rate during the reaction, and/or the diluent may be used to allow temperature adjustments when it is not desirable to etch the material. For example, the diluent may be passed through a heater during start-up or shut down of the process, while the heater is being heated or cooled, with the etchant added to the reaction gas while the heater is at the desired temperature for etching.

In the heaters described above, etching may be conducted at temperatures from 700° C. to 1400° C., for example, from 900° C. to 1100° C. The process temperature is the average temperature of the graphitic carbon black while contacting the graphitic carbon black with the etchant and catalyst to increase the porosity of the graphitic carbon black.

Other process conditions that may be adjusted include the flow rate and/or velocity of the reaction gas. Ideally, the flow rate or velocity should not be so high that it entrains the graphitic carbon and removes it from the reactor. One of skill in the art will recognize how to adjust the flow rate and/or velocity of the reaction gas to achieve favorable reaction conditions, e.g., causing graphitic carbon in a fluidized bed reactor to behave in a fluidized manner. In some embodiments. e.g., in a fluidized bed reactor, it may be necessary to perform the etching at elevated pressure. The mass ratio of cumulative etchant with respect to the starting amount of graphitic carbon black may also be adjusted via adjustments to the reaction time, the mass loading of the graphitic carbon starting material, and the fill factor of the heater, along with the flow rate, the velocity, the partial pressure of etchant, and the ratio of etchant to diluent of the reaction gas. Any of these process conditions, along with the reaction time and the amount of strontium and/or barium, may be adjusted to control the degree of etching of the graphitic carbon black.

Optionally, the method is performed with a densed or pelletized graphitic carbon black. Densed or pelletized carbon black can provide desirable flow and fluidization characteristics that ease handling and/or transport of the graphitic carbon black during the various etching processes provided herein. Any of a variety of conventional carbon black pelletization techniques may be employed to pelletize a non-pelletized carbon black material and form a pelletized carbon black starting material. For example, pellets can be formed via wet pelletization, in which fine carbon black powder is fed to a pin mixer with water and then mixed under high shear. Polymeric or small molecule binders can also be added to the water to improve pellet hardness or durability. Another method of pelletizing is dry pelletization, in which fine carbon black powder is fed to a large rotary drum where it is mixed with recycled (or seed) pellets, and the rotating action of the drum causes the fine powder to mix and incorporate with the pellets. Alternatively or in addition, a press or other densing apparatus such as a roll compactor may be used to densify the graphitic carbon black.

In some exemplary embodiments, pelletized carbon black starting material has an average pellet size greater than about 25 μm, e.g., greater than about 50 μm, greater than about 100 μm, greater than about 200 μm, greater than about 500 μm, or greater than about 1 mm. In terms of ranges, pelletized carbon black starting material, optionally has an average pellet size of from about 10 μm to about 5 mm, e.g., from about 100 μm to about 5 mm, or from about 200 μm to about 2 mm. The carbon black starting material optionally has a pellet size distribution with 0% to 3% by weight greater than 2 mm, 15% to 80% by weight between 1 and 2 mm, 15% to 80% by weight between 500 μm and 1 mm, 1% to 15% by weight between 250 μm and 500 μm, 0% to 10% by weight between 125 μm and 250 μm, and 0% to 5% by weight less than 125 μm. In this context, the pellet size distribution and average pellet size is determined by passing the carbon black pellets through a vibrating series of stacked sieves with decreasing mesh size and then measuring the mass collected on each sieve as per ASTM D1511-00, the entirety of which is incorporated herein by reference.

Preferably, pelleted graphitic carbon black starting material is substantially free of carbon black fines, defined herein as the fraction of carbon black particles passing through a #120 mesh sieve, e.g., having a pellet size less than about 125 μm. In various optional embodiments, pelletized carbon black starting material comprises less than about 15 weight percent carbon black fines, e.g., less than about 10 weight percent, less than about 5 weight percent or less than about 2 weight percent carbon black fines.

Alternatively or in addition, etching may be performed immediately following formation of the crystalline carbon black. For example, an etchant, along with strontium or barium, may be introduced to a carbon black reactor following formation of the carbon black. In this case, the temperature may be closer to the temperature at which the carbon black was formed, for example, at least 1600° C., or from 1600° C. to 2500° C. or from 2200° C. to 2700° C. In some embodiments, following decomposition of the acetylene and formation of the carbon black, steam and strontium are introduced into the carbon black reactor to effect etching of the carbon black. For example, steam and strontium may be introduced to the reactor in a region downstream of a region in which carbon black is formed.

Without being bound by any particular theory, it is believed that the etching operates by removing carbon atoms from the surface and forming carbon monoxide and carbon dioxide gases, thus reducing the mass of the graphitic carbon black. In certain embodiments, up to 85% of the mass of the graphitic carbon black is removed, for example, from 2% to 5%, from 5% to 10%, from 10% to 50%, from 20% to 60%, from 30% to 85%, from 40% to 75%, from 50% to 65%, or from 60% to 85%. Alternatively or in addition, the BET surface area of the etched carbon black may be at least 2 times that of the starting material, for example, at least 2.5 times that of the starting material, for example, from 2.5 times to 8 times, from 3 times to 7.5 times, from 3.5 times to 7 times, from 4 times to 6.5 times, from 4.5 times to 6 times, from 5 times to 7.5 times, or from 5.5 times to 8 times the BET surface area of the starting material.

We have unexpectedly found that strontium and barium improve the etching rate with respect to both a lack of catalyst and with respect to the use of lighter elements such as calcium. The use of strontium, barium, or a mixture of both may change the reaction rate (the rate of mass loss), by at least 10% with respect to etching in which these elements are not used, for example, by 10% to 80%, by 15% to 75%, by 20% to 65%, by 25% to 60%, or by 30% to 55%. The change in reaction rate is calculated as [(reaction rate with strontium and/or barium)−(reaction rate without strontium and/or barium)]/(reaction rate without strontium and/or barium).

Etching also increases the pore volume of the graphitic carbon black. Nonetheless, the use of strontium and/or barium may increase the pore volume of pores with 2-6 nm diameter by at least 2.5% than without the use of these elements. For example, a strontium and/or barium catalyst may increase the pore volume of pores with 2-6 nm diameter by 2.5% to 210%, for example, from 5% to 150%, from 10% to 100%, or from 20% to 50% with respect to graphitic carbon black etched without these elements. As a result, the cumulative pore volume of pores having a diameter of 2 nm-6 nm may be at least 0.1 cc/g, for example, from 0.1 cc/g to 0.6 cc/g or 0.1 cc/g to 0.3 cc/g. Alternatively or in addition, the a cumulative pore volume in cc/g of pores having a diameter of 2 nm-6 nm may be at least 0.0004(BET)-0.048, for example, between 0.0004(BET)-0.048 and 0.6 cc/g. Mean pore diameters and pore volumes can be determined in accordance with the techniques described in E. P. Barrett, L. G. Joyner, P. P. Halenda, J. Am. Chem. Soc. 1951, 73, 373-380 (BJH method).

The porous graphitic carbon black may retain its graphitic nature. For example, the porous graphitic carbon black may have a Raman planar size (La) of at least 21.5 Angstroms, for example, from 21.5 Angstroms to 45 Angstroms or 21.5 Angstroms to 40 Angstroms.

The porous graphitic carbon black may have a BET surface area of 150 m²/g to 2000 m²/g, for example, from 200 m²/g to 400 m²/g, from 400 m²/g to 600 m²/g, from 600 m²/g to 800 m²/g, from 800 to 1000 m²/g, from 1000 m²/g to 1200 m²/g, from 1200 to 1400 m²/g, from 1400 to 1600 m²/g, from 1600 m²/g to 1800 m²/g, or from 1800 m²/g to 2000 m²/g, or in any range defined by any two of these endpoints.

Alternatively or in addition, the porous graphitic carbon black may have a crystallite size Lc of at least 10 Angstroms, for example, at least 15 Angstroms, at least 17 Angstroms, from 20 to 80 Angstroms, from 25 to 75 Angstroms, or from 25 to 70 Angstroms.

The porous graphitic carbon black may have improved powder resistivity in comparison to the unetched graphitic carbon black. For example, the porous graphitic carbon black may have a higher powder resistivity on a mass basis or on a volume basis or both. Powder resistivity may be measured by a four point method using a commercial powder resistivity & compact density analyzer, for example, the PRCD2100 instrument from IEST-Yuanneng Technology.

The porous graphitic carbon black may have a total concentration of strontium and barium of at least 100 ppm by mass, for example, from 200 ppm to 500 ppm, from 500 to 1000 ppm, from 1000 to 2000 ppm, from 2000 to 3000 ppm, from 3000 to 5000 ppm, from 5000 to 10000 ppm, from 10000 to 15000 ppm, or from 15000 to 20000 ppm, for example, from 100 ppm to 20000 ppm.

The porous graphitic carbon black may be used in a variety of end use applications. The combination of high surface area, e.g., at least 150 m²/g, high porosity, e.g., cumulative pore volume in of pores having a diameter of 2 nm-6 nm of at least 0.1 cc/g, and high crystallinity, e.g., Raman planar size (La) of at least 21.5 Angstroms, renders the porous graphitic carbon blacks provided herein highly electrically conductive. Such carbon blacks may provide benefits in conductive plastics, electrodes for fuel cells such as direct methanol fuel cells (DMFC) or hydrogen fuel cells, catalyst supports, e.g., for fuel cell applications, and in supercapacitors.

In one implementation, the porous graphitic carbon black is used in forming conductive plastics. Carbon black is highly electrically conductive and is therefore added to (normally non-conductive) plastics at sufficient levels to achieve a percolating network of carbon black, thereby resulting in the plastic part or film becoming electrically conductive. Generally, achieving electrical percolation at lower mass loadings of carbon black can be advantageous in that it can impart other advantages to the plastic, such as viscosity, fracture toughness, adhesion, density, or other properties. The graphitic nature of the carbon black can also increase melt flow index (MFI), as disclosed in U.S. Ser. No. 11/732,174, the entire contents of which are incorporated herein by reference, thereby increasing the processability of plastics in comparison to less graphitic carbon blacks.

In another implementation, catalyst particles include a porous graphitic carbon black as provided herein along with an active phase disposed on the porous graphitic carbon black, which acts as a support phase for the active phase. For example, catalyst particles may be formed in a spray conversion reactor in which a liquid mixture is formed comprising carbon support particles, i.e., porous graphitic carbon black particles, an active phase precursor, and a liquid vehicle. The liquid mixture is sprayed at elevated temperatures under conditions effective to vaporize the liquid vehicle and convert the active phase precursor to active phase disposed on the carbon support particles. In other embodiments, the active phase is not fully formed in the spray converting step and a further heat treatment step is employed after spraying. Alternatively, wet precipitation processes may be employed to form catalyst particles on the carbon black product.

In another implementation, porous graphitic carbon black particles or catalyst particles prepared with porous graphitic carbon black are used to fabricate electrodes for fuel cells such as DMFC or hydrogen fuel cells. In some embodiments, the particles are formulated into an ink that is deposited onto carbon cloth or carbon paper or directly on a membrane such as a polymer electrolyte membrane. Depositing may be accomplished by spray deposition, pen/syringe, continuous or drop on demand ink-jet printing, droplet deposition, spraying, flexographic printing, lithographic printing, gravure printing, other intaglio printing, and others.

Alternatively or in addition, the porous graphitic carbon black may be used in silicon-carbon composites. Silicon-carbon composites are employed in the anodes of lithium ion batteries to improve the cycling performance of silicon anodes. Carbon black in such composites is used to improve conductivity. While crystalline carbon blacks are generally more conductive than amorphous carbon blacks, increasing the porosity of the carbon black dramatically increases the conductivity. The crystallinity not only improves conductivity but also the durability of the carbon black particles. In addition, the etched graphitic carbon black can serve as a scaffold and reservoir for the silicon phase to constrain and manage silicon particle expansion during lithiation.

Alternatively or in addition, the porous graphitic carbon black may be used to improve the stability of conductive additives in cathode materials operated in high voltage or high temperature environments. The manipulation of the formulations for nickel-cobalt-manganese electrode materials, especially the increased proportion of nickel, is increasing the energy density of batteries based on these materials. The use of graphitic carbon blacks can improve the stability of conductive additives in cathode compositions for high voltage batteries, and the porous graphitic carbon blacks provided herein can provide increased conductivity in comparison to graphitic carbon blacks that have not been etched. Likewise, the combination of crystallinity and porosity in the carbon blacks provided herein also improve stability under higher temperature operating conditions, e.g., between 50 and 70° C. instead of closer to room temperature.

### EXAMPLES

Carbon black samples were prepared by weighing out 100 g (for acetylene black) or 300 g (all other samples) carbon black and placing it in a approximately 12 in×8 in (30.5 cm×29.3 cm) stainless steel tray, giving a bed depth of about 0.5 in (1.3 cm). The tray was tared, and a 30 wt % solution of strontium nitrate or calcium nitrate in deionized water was sprayed onto the carbon black in five aliquots. In between each addition, the sample was shaken by hand for about 30 s to mix the coated top layer with the remainder of the sample. Once the desired mass of catalyst solution was added (indicated as a total amount of Sr or Ca in the Examples below; treatment conditions used equimolar amounts of Sr or Ca), the sample was transferred to a container that was suitable for use with the rotary kiln.

Steam etching was conducted in a rotary kiln having a working volume of two liters. The kiln was maintained at a constant heater set point of 1050° C. when in standby mode. Prior to each experiment, the deionized water reservoir was filled, the steam generator was preheated above 200° C., and the incinerator pilot light was lit. To steam etch a sample, carbon black was loaded to a loading/cooling collar. The kiln conveyed the carbon black from the collar into the hot zone, which was maintained at a setpoint of 1050° C., 1 L/min nitrogen flow, 100 g/hr steam flow, and 4.5 rpm tube rotation. Runtimes were varied depending on the reaction rate of the sample and the desired degree of etching and varied from 1-15 hours. Once the runtime was complete, the rotation of the kiln was reversed to convey the carbon out of the hot zone and return it to the loading/cooling collar, where it was cooled for 30 min under nitrogen and then weighed. The degree of etch as a percentage was (100*(Mass Start−Mass End)/Mass Start).

### Example 1

Samples of highly graphitic and amorphous carbon were steam etched with no catalyst, 0.0883 g strontium nitrate solution/g carbon, or 0.068 g calcium nitrate solution/g carbon. FCX 80 and LITX HP conductive carbons from Cabot Corporation are highly graphitic carbons with an aciniform structure and substantially uniform primary particle size, and CSX 960 and Spheron® 5000A carbon blacks from Cabot Corporation are amorphous carbon blacks. AB50P acetylene black was densed by placing 100 g in a woven polyethylene filter envelope and pressing twice in a hydraulic press at 30 tons of force for 1 minute. Exp CB1 was produced by heat treating Vulcan® XC72 carbon black (Cabot Corporation) at a temperature from 1300° C. to 1500° C. until Lc of 46 Angstroms was achieved. Exp CB2 was produced by heat treating CSX960 carbon black at a temperature of 1400° C. to 1600° C. until Lc of 36 Angstroms was achieved. The same molar amount of Sr and Ca were used on catalyzed samples. The reaction time was varied to achieve a consistent degree of etch between the catalyst-added samples and the catalyst-free comparative samples. As necessary, etched samples were returned to the kiln for additional etching to achieve the desired degree of etch, with the total runtime and the final mass used in calculations of reaction rate. The etching results are shown in Tables 1-3 below. Surface area was measured according to ASTM D6556 with samples outgassed at 300° C. for one hour under nitrogen flow and measurements made over the nitrogen partial pressure range 0.05-0.1 P/Pₒ. The amount of strontium or calcium present on the etched black was measured by inductively coupled plasma as follows. A 5-10 mg sample was ashed using a muffle furnace as described in ASTM D1506. The resulting ash was combined with 2 mL concentrated HCl, 0.5 mL concentrated HNO3, and a small amount of reagent grade water. The sample was then brought to 50 mL with yttrium as an internal standard and reagent grade water and analyzed using an Agilent ICP-OES Model 5110 spectrometer. Moderate amounts of calcium present on samples etched with strontium, and vice versa, likely result from contamination by residual material in the reactor from previous experiments. Similar contamination may have occurred with samples etched without an additive. Mean pore diameters and pore volumes were determined in accordance with the techniques described in E. P. Barrett, L. G. Joyner, P. P. Halenda, J. Am. Chem. Soc. 1951, 73, 373-380 (BJH method).

TABLE 1

| | | | Reaction | | Raman | |
|---|---|---|---|---|---|---|
| Carbon | % | | rate | BET | La | Lc |
| Sample | Etch | Additive | (g/hr) | (m²/g) | (ang) | (ang) |
| FCX80 | 0% | None | — | 78 | 66.1 | 59.6 |
| FCX80 | 82% | None | 17.2 | 261.7 | 25.5 | 66.1 |
| FCX80 | 76% | Sr | 28.6 | 605.5 | 24.5 | 48.0 |
| FCX80 | 76% | Ca | 16.4 | 309.7 | 21.9 | |
| Exp. CB1 | 0% | None | — | 100 | 41.6 | 46.0 |
| Exp. CB1 | 62% | None | 20.6 | 197.0 | 31.3 | 51.9 |
| Exp. CB1 | 62% | Sr | 32.0 | 339.0 | 36.6 | 46.3 |
| Exp. CB1 | 44% | Ca | 14.5 | 179.8 | 32.2 | |
| AB50P | 0% | None | — | 79.8 | 38 | 29.5 |
| Densified | | | | | | |
| AB50P | 57% | None | 28.6 | 426.5 | 24.8 | 31.2 |
| Densified | | | | | | |
| AB50P | 63% | Sr | 31.4 | 536.8 | 23.4 | 29.7 |
| Densified | | | | | | |
| AB50P | 53% | Ca | 26.7 | 408.6 | 26.3 | |
| Densified | | | | | | |
| Exp. CB2 | 0% | None | — | 94 | 48.0 | 36.0 |
| Exp. CB2 | 41% | None | 15.2 | 323.7 | 32.7 | 33.6 |
| Exp. CB2 | 33% | Sr | 22.8 | 305.7 | 25.5 | 36.4 |
| LITXHP | 0% | None | — | 95 | 27 | 20.7 |
| LITXHP | 61% | None | 22.8 | 441.3 | 28.3 | 25.8 |
| LITXHP | 61% | Sr | 27.2 | 425.6 | 25.9 | 23.2 |
| CSX960 | 0% | None | — | 125 | 14.5 | 15.3 |
| CSX960 | 74% | None | 28.4 | 1122.7 | 18.6 | 12.4 |
| CSX960 | 74% | Sr | 32.3 | 1301.8 | 18.9 | 11.1 |
| Spheron | 0% | None | — | 27.2 | | |
| 5000A | | | | | | |
| Spheron | 70% | None | 29.2 | 665.7 | 20.7 | 13.6 |
| 5000A | | | | | | |
| Spheron | 68% | Sr | 34.4 | 651.5 | 20.4 | 15.0 |
| 5000A | | | | | | |

TABLE 2

| Carbon | | | Sr on etched | Ca on etched |
|---|---|---|---|---|
| Sample | % Etch | Additive | black (ppm) | black (ppm) |
| FCX80 | 0% | None | | |
| FCX80 | 82% | None | 995 | 17 |
| FCX80 | 76% | Sr | 12973 | 54 |
| FCX80 | 76% | Ca | 1974 | 9522 |
| Exp. CB1 | 0% | None | | |
| Exp. CB1 | 62% | None | 339 | 66 |
| Exp. CB1 | 62% | Sr | 5449 | 14 |
| Exp. CB1 | 44% | Ca | 303 | 6244 |
| AB50P | 0% | None | | |
| Densified | | | | |
| AB50P | 57% | None | 1373 | 22 |
| Densified | | | | |
| AB50P | 63% | Sr | 18644 | 42 |
| Densified | | | | |
| AB50P | 53% | Ca | 498 | 4146 |
| Densified | | | | |
| Exp. CB2 | 0% | None | | |
| Exp. CB2 | 41% | None | 19 | 11 |
| Exp. CB2 | 33% | Sr | 3988 | 3.4 |
| LITXHP | 0% | None | | |
| LITXHP | 61% | None | 20 | 11 |
| LITXHP | 61% | Sr | 2836 | 5 |
| CSX960 | 0% | None | | |
| CSX960 | 74% | None | 36 | 7 |
| CSX960 | 74% | Sr | 1235 | <5 |
| Spheron | 0% | None | | |
| 5000A | | | | |
| Spheron | 70% | None | 3794 | 385 |
| 5000A | | | | |
| Spheron | 68% | Sr | 31590 | 170 |
| 5000A | | | | |

TABLE 3

| Carbon | % | | Pore volume (cm³/g) by pore size (nm) | | | | |
|---|---|---|---|---|---|---|---|
| Sample | Etch | Additive | <2 nm | 2-6 nm | 6-10 nm | 10-50 nm | >50 nm |
| FCX80 | 0% | None | | | | | |
| FCX80 | 82% | None | 0.008 | 0.092 | 0.046 | 10.17 | 0.31 |
| FCX80 | 76% | Sr | 0.008 | 0.216 | 0.151 | 0.54 | 0.75 |
| FCX80 | 76% | Ca | 0.009 | 0.104 | 0.08 | 0.31 | 0.49 |
| Exp. CB1 | 0% | None | | | | | |
| Exp. CB1 | 62% | None | 0.0 | 0.059 | 0.035 | 0.2 | 0.3 |
| Exp. CB1 | 62% | Sr | 0.013 | 0.180 | 0.106 | 0.380 | 0.650 |
| Exp. CB1 | 44% | Ca | 0.005 | 0.052 | 0.03 | 0.15 | 0.30 |
| AB50P | 0% | None | | | | | |
| Densified | | | | | | | |
| AB50P | 57% | None | 0.013 | 0.163 | 0.089 | 0.21 | 0.24 |
| Densified | | | | | | | |
| AB50P | 63% | Sr | 0.012 | 0.185 | 0.093 | 0.22 | 0.25 |
| Densified | | | | | | | |
| AB50P | 53% | Ca | 0.012 | 0.146 | 0.09 | 0.21 | 0.24 |
| Densified | | | | | | | |
| Exp. CB2 | 0% | None | | | | | |
| Exp. CB2 | 41% | None | 0.009 | 0.111 | 0.067 | 0.25 | 0.37 |
| Exp. CB2 | 33% | Sr | 0.009 | 0.114 | 0.049 | 0.2 | 0.37 |
| LITXHP | 0% | None | | | | | |
| LITXHP | 61% | None | 0.011 | 0.147 | 0.115 | 0.41 | 0.55 |
| LITXHP | 61% | Sr | 0.012 | 0.151 | 0.045 | 0.19 | 0.36 |
| CSX960 | 0% | None | | | | | |
| CSX960 | 74% | None | 0.029 | 0.513 | 0.198 | 0.37 | 0.81 |
| CSX960 | 74% | Sr | 0.04 | 0.547 | 0.107 | 0.38 | 0.67 |
| Spheron | 0% | None | | | | | |
| 5000A | | | | | | | |
| Spheron | 70% | None | 0.02 | 0.242 | 0.081 | 0.15 | 0.24 |
| 5000A | | | | | | | |
| Spheron | 68% | Sr | 0.02 | 0.203 | 0.033 | 0.07 | 0.2 |
| 5000A | | | | | | | |

The results demonstrate that the use of strontium as a catalyst for the graphitic samples resulted in an increased etching rate in comparison to the use of calcium, which did not increase etching rates in comparison to catalyst-free comparative samples and which resulted in less surface area for a comparable degree of etching (mass loss).

### Example 2

Samples of graphite flake having a Raman La well over 20 Å (Millipore Sigma) were steam etched with no catalyst or 0.085 g strontium nitrate solution/g carbon. The reaction times and results are listed in Table 4 below.

TABLE 4

| Carbon | | | Reaction | Reaction |
|---|---|---|---|---|
| Sample | % Etch | Additive | Time (hr) | rate (g/hr) |
| Graphite Flake | 0% | None | | |
| Graphite Flake | 69% | Sr | 10 | 17.3 |
| Graphite Flake | 12% | None | 10 | 3.1 |
| Graphite Flake | 35% | Sr | 3 | 11.7 |
| Graphite Flake | 7% | None | 3 | 6.7 |

During catalyst-free etching of the graphite flake samples, no flame was visible at the exit of the kiln. In contrast, a significant flame was observed at the exit of the kiln with the use of strontium. It is believed that a significant portion of the mass loss on the comparative graphite flake samples (no strontium) was due to loss of the binder, not etching of the graphite. Regardless of the source of mass loss, the use of strontium dramatically increased the etching rate of the highly crystalline graphite.

The foregoing description of various embodiments has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A carbon black having the following characteristics: Raman planar size (La) of at least 21.5 Angstroms, a cumulative pore volume of pores having a diameter of 2 nm-6 nm of at least 0.1 cc/g, and at least 200 ppm strontium, barium, or both.

2. The carbon black of claim 1, having a BET surface area of 150 m²/g to 2000 m²/g.

3. The carbon black of claim 1, having a cumulative pore volume in cc/g of pores having a diameter of 2 nm-6 nm of at least 0.0004(BET)-0.048, wherein BET is the BET surface area according to ASTM 6556 with samples outgassed at 300° C. for one hour under nitrogen flow and measurements made over the nitrogen partial pressure range 0.05-0.1 P/Pₒ.

4. The carbon black of claim 1, having a crystallite size Lc of at least 10 Angstroms.

5. A method of increasing porosity of graphitic carbon black, comprising:
combining graphitic carbon black having a Raman planar size (La) of at least 20 Angstroms with at least 100 ppm of an alkaline earth element selected from strontium, barium, and a mixture of both to form a mixture; and
contacting the mixture with an etchant at a temperature of 900-1400° C. until 2%-85% of the mass of the carbon black is lost.

6. The method of claim 5, wherein the graphitic carbon black, prior to contacting, has a crystallite size Lc of at least 10 Angstroms.

7. The method of claim 5, wherein contacting is performed until a BET surface area of the carbon black is at least doubled, for example, at least trebled.

8. The method of claim 1, wherein the rate of mass loss is at least 10% greater than without the use of strontium or barium

9. The method of claim 1, wherein the increase in pore volume of pores with 2-6 nm diameter is at least 2.5% greater than without the use of strontium or barium.

10. The method of claim 1, wherein the etchant is selected from the group consisting of O₂, O₃, an oxygen-containing acid, water (e.g., steam), CO₂, and combinations of two or more of these.

11. A method of producing porous graphitic carbon black, comprising:
thermally decomposing hydrocarbon feedstock to obtain graphitic carbon black; and
contacting the graphitic carbon black with an etchant and at least 100 ppm of an alkaline earth element selected from strontium, barium, and a mixture of both to form a mixture.

12. The method of claim 11, wherein thermally decomposing and contacting are performed in a single reactor.

13. The method of claim 11, wherein contacting is performed at a temperature from 1600° C. to 2700° C.

14. The method of claim 11, wherein the etchant is selected from the group consisting of O₂, O₃, an oxygen-containing acid, water (e.g., steam), CO₂, and combinations of two or more of these.

15-20. (canceled)
